(19) United States
(12) Patent Application Publication
(10) Pub. No.: US 2025/0390317 A1
(43) Pub. Date: Dec. 25, 2025

(54) SYSTEMS AND METHODS FOR PROVIDING A USER INTERFACE WITH RECURSIVE ELEMENTS AND DYNAMIC ERROR HANDLING

(71) Applicant: Verizon Patent and Licensing Inc., Basking Ridge, NJ (US)

(72) Inventors: Pankaj RAI, Mania Mirzabad, IN (US); Viraj Chandrakant MANTRI, Hyderabad (IN); Srividhya PARTHASARATHY, Chennai (IN); Pranay BAJPAI, Flower Mound, TX (US); Kedar V. PHADKE, Hyderabad (IN)

(73) Assignee: Verizon Patent and Licensing Inc., Basking Ridge, NJ (US)

(21) Appl. No.: 18/751,719

(22) Filed: Jun. 24, 2024

(51) Int. Cl. G06F 9/451; H04L 67/50

(52) U.S. Cl. CPC G06F 9/451; H04L 67/535

(57) ABSTRACT

A device may receive a usage pattern of a user of a client device, and may receive a request for a user interface from the client device. The device may generate one or more elements of the user interface based on the request, and may prompt a large language model, with the usage pattern, to generate one or more additional elements of the user interface. The device may combine the one or more elements and the one or more additional elements to generate the user interface, and may provide the user interface to the client device.

### BACKGROUND

User interface (UI) development within server-driven frameworks often presents challenges for code developers who are tasked with creating code for layouts and actual content within those layouts to be rendered on a client device.

### BRIEF DESCRIPTION OF THE DRAWINGS

FIGS. 1A-1H are diagrams of an example associated with providing a user interface with recursive elements and dynamic error handling.

FIG. 2 is a diagram of an example environment in which systems and/or methods described herein may be implemented.

FIG. 3 is a diagram of example components of one or more devices of FIG. 2.

FIG. 4 is a flowchart of an example process for providing a user interface with recursive elements and dynamic error handling.

### DETAILED DESCRIPTION OF EXAMPLE EMBODIMENTS

The following detailed description of example implementations refers to the accompanying drawings. The same reference numbers in different drawings may identify the same or similar elements.

Constructing complex user interfaces can be cumbersome, as it necessitates writing extensive code that may be prone to errors. This increased likelihood of coding errors can lead to a variety of issues such as visual glitches, misalignments, and functionality problems that negatively impact a user experience. Thus, current techniques for providing user interfaces consume computing resources (e.g., processing resources, memory resources, communication resources, and/or the like), networking resources, and/or other resources associated with generating complex user interfaces on the client side, generating and handling user interface errors that impact user interface stability and performance, creating redundant server-client interactions and extensive data transfers associated with user interfaces, requiring frequent updates and maintenance of user interfaces, and/or the like.

Some implementations described herein provide a user interface system that provides a user interface with recursive elements and dynamic error handling. For example, the user interface system may receive a usage pattern of a user of a client device, and may receive a request for a user interface from the client device. The user interface system may generate one or more elements of the user interface based on the request, and may prompt a large language model, with the usage pattern, to generate one or more additional elements of the user interface. The user interface system may combine the one or more elements and the one or more additional elements to generate the user interface, and may provide the user interface to the client device.

In this way, the user interface system provides a user interface with recursive elements and dynamic error handling. For example, the user interface system may facilitate more efficient and dynamic rendering of user interfaces on client devices. The user interface system may receive a usage pattern of a user of a client device and a request for a user interface from the client device. The user interface system may generate one or more elements of the user interface based on the request and may prompt a large language model with the usage pattern to generate one or more additional elements of the user interface. The user interface system may provide the combination of elements to the client device as a complete user interface, which may include a node structure corresponding to a column layout, a row layout, or a box layout for dynamically arranging the elements. The user interface system may designate portions of the user interface for asynchronous loading, and may provide backup user interfaces in case of errors with the user interface. The user interface system may detect and correct errors in the user interface with the assistance of another large language model.

Thus, the user interface system may conserve computing resources, networking resources, and/or other resources that would have otherwise been consumed by generating complex user interfaces on the client side, generating and handling user interface errors that impact user interface stability and performance, creating redundant server-client interactions and extensive data transfers associated with user interfaces, requiring frequent updates and maintenance of user interfaces, and/or the like. For example, the pixel-level control afforded by the node structure may enable the user interface system to provide adjustments and resource optimization for varying client device capabilities and networks. The automatic error correction by the user interface system may ensure more seamless user interface delivery with reduced latency and increased fault tolerance. The utilization of large language models for dynamically generating user interfaces tailored to a usage pattern can effectively conserve processing resources by eliminating redundant interactions and reducing a need for extensive data transfers. The user interface system may also reduce the need for frequent updates and maintenance of user interfaces.

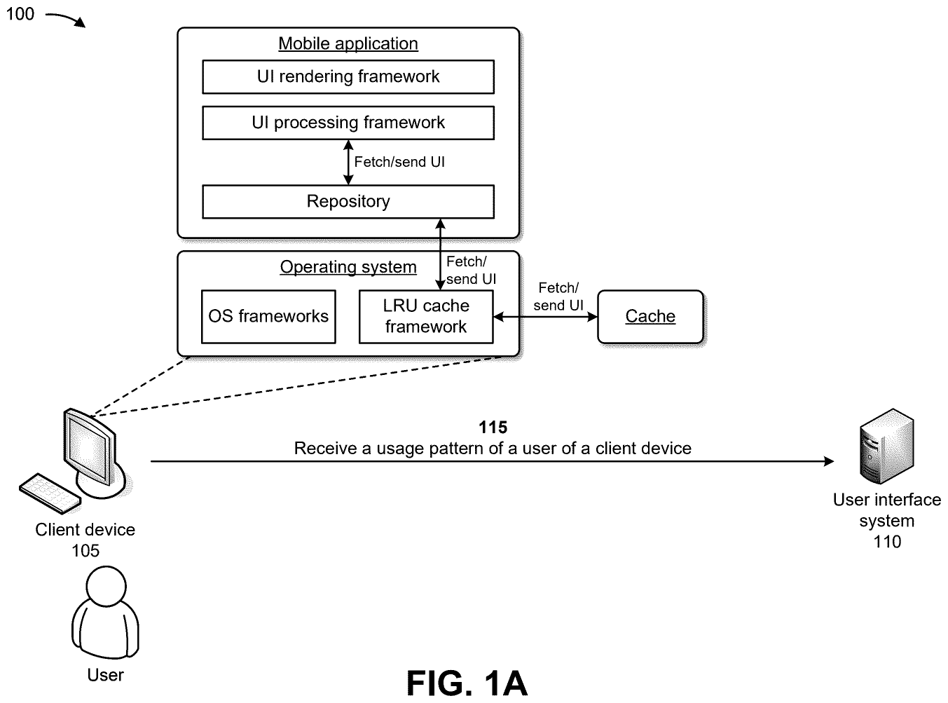

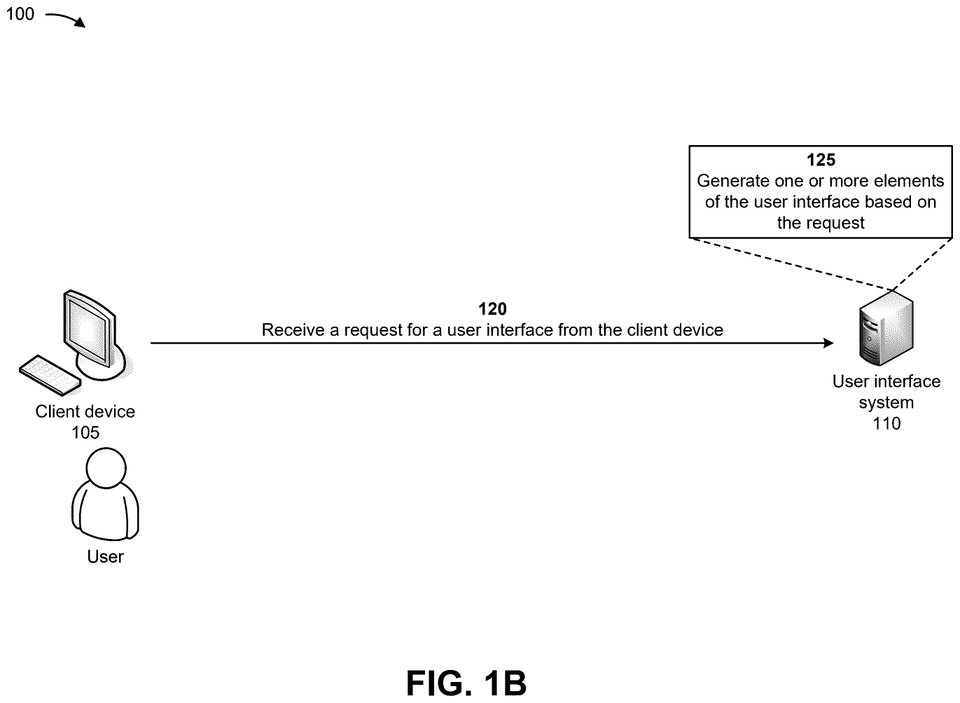

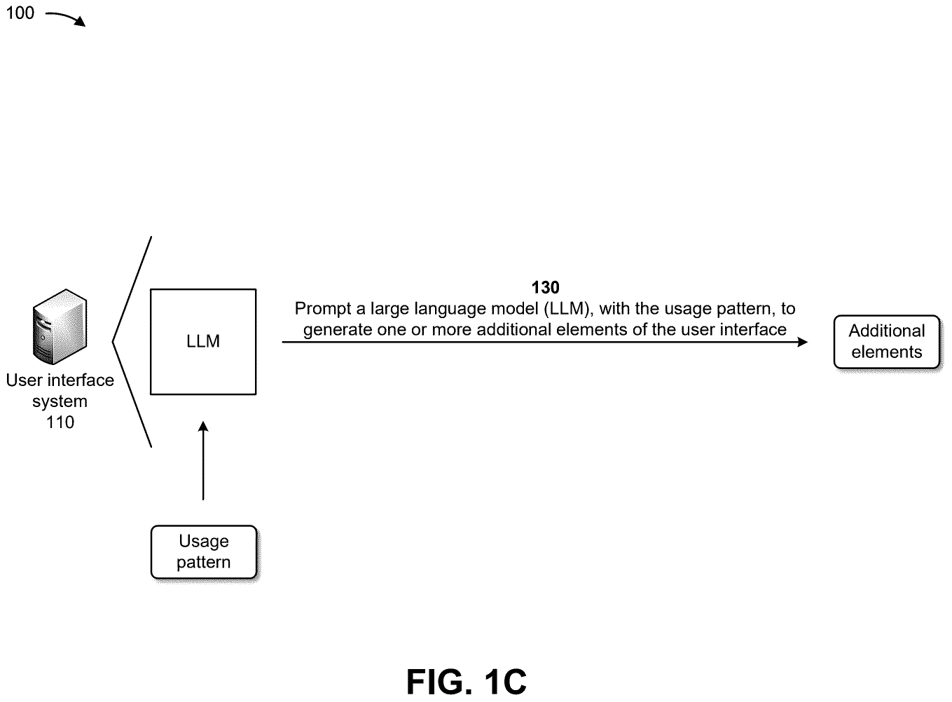

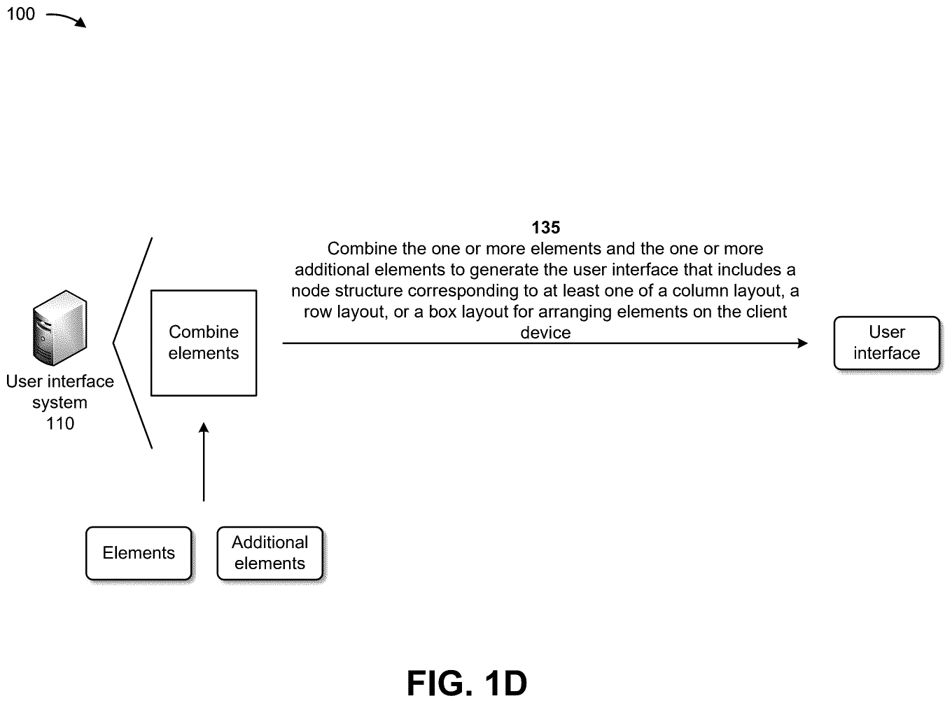

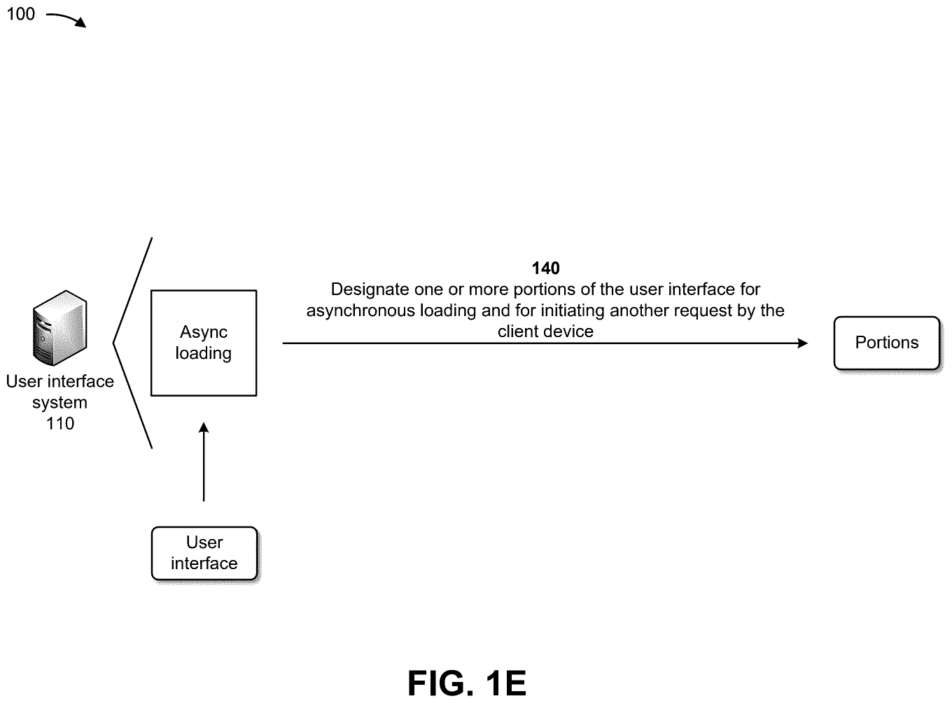

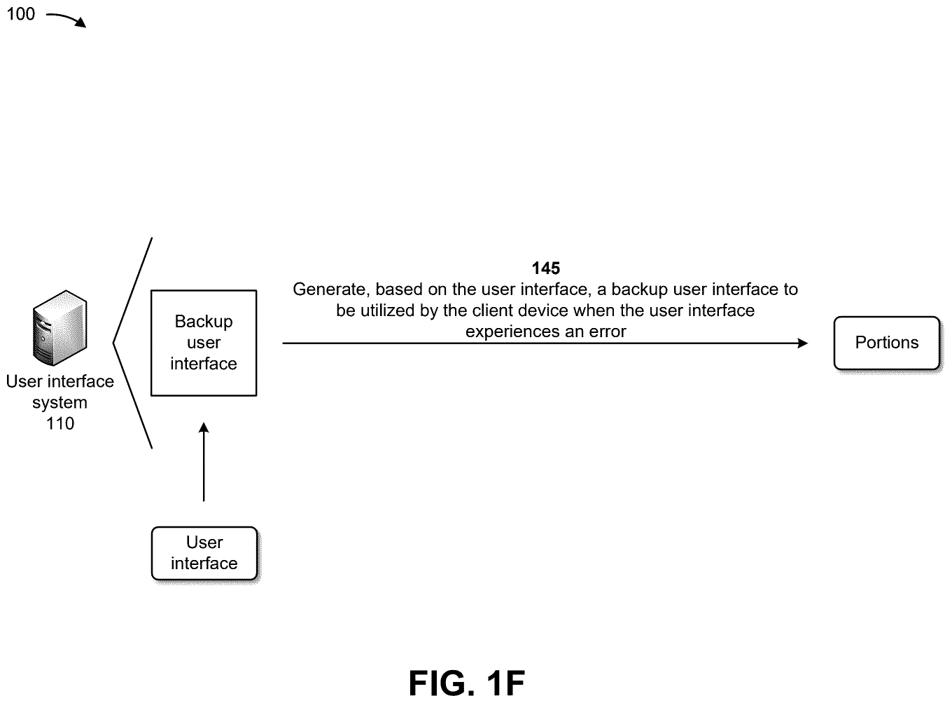

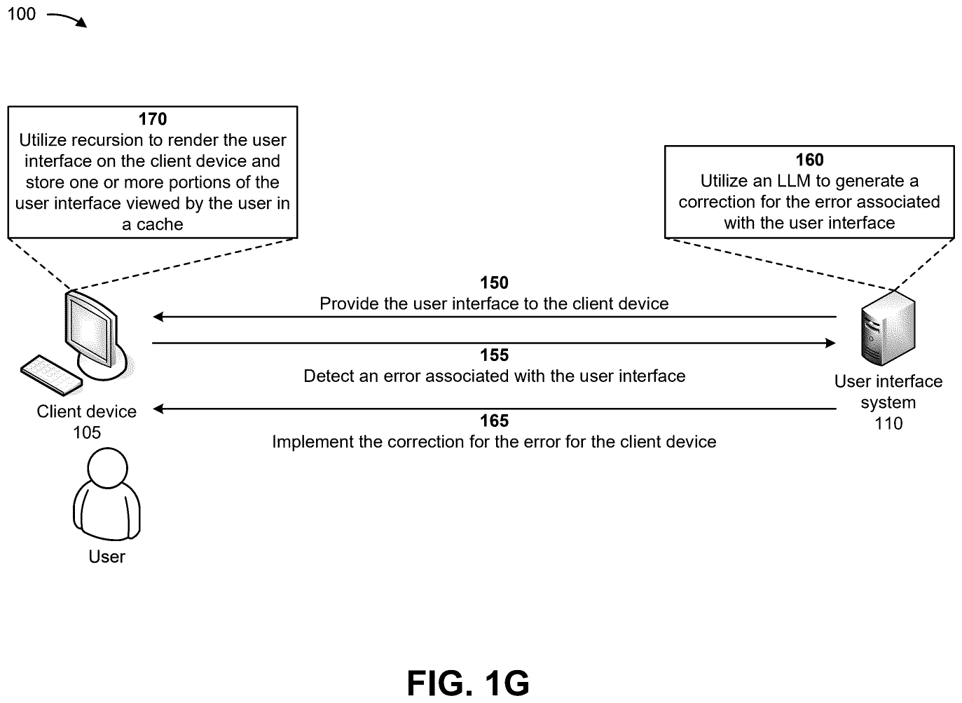

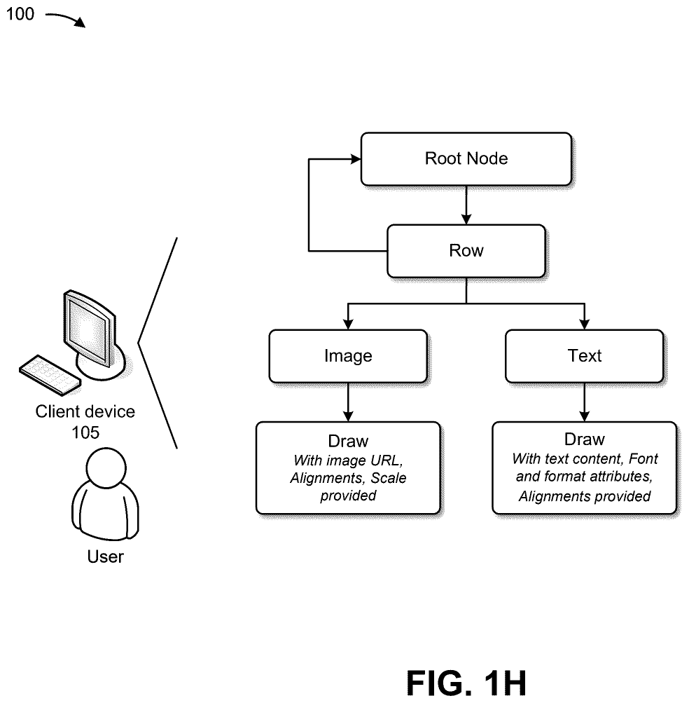

FIGS. 1A-1H are diagrams of an example 100 associated with providing a user interface with recursive elements and dynamic error handling. As shown in FIGS. 1A-1H, example 100 includes a client device 105 associated with a user interface system 110. Although a single client device 105 is depicted in the example 100, in some implementations, the user interface system 110 may be associated with multiple client devices 105. Further details of the client device 105 and the user interface system 110 are provided elsewhere herein.

As shown in FIG. 1A, the client device 105 may include a mobile application with a UI rendering framework, a UI processing framework, and a repository. The client device 105 may also include a cache, and an operating system (OS) with OS frameworks and a last recently used (LRU) cache framework. The mobile application may include any mobile application capable of being executed by the client device 105 and including one or more user interfaces with one or more user interface elements. In some implementations, when the client device 105 is a desktop computer, the mobile application may be an application capable of being executed by the desktop computer.

The UI rendering framework may include one or more components to render the user interfaces of the mobile application on a display component of the client device 105. The UI processing framework may include one or more components to process the user interfaces of the mobile application. The repository may include a data structure (e.g., a database, a table, a list, and/or the like) that permanently stores the mobile application on the client device 105. The cache may include a data structure that temporarily stores one or more portions of a user interface of the mobile application. The operating system may include system software that manages hardware and software resources of the client device 105 and provides common services for applications, such as the mobile application. The OS frameworks may include one or more components that manage the hardware and software resources of the client device 105. The LRU cache framework may include one or more components that temporarily store last recently used portions of a user interface of the mobile application in the cache.

As further shown in FIG. 1A, and by reference number 115, the user interface system 110 may receive a usage pattern of a user of the client device 105. For example, the user interface system 110 may collect data representing the user's interactions with the client device 105, such as user behaviors, user preferences, frequently accessed content, past usage statistics, and/or the like. The data may be referred to as a usage pattern of the user of the client device 105. The usage pattern may provide the user interface system 110 with contextual information to enhance the responsiveness and personalization of the user interface generated for the client device 105.

In some implementations, the usage pattern may be received directly from the client device 105 or may be determined based on analysis of user interactions with applications executing on the client device 105. For example, the analysis of the user interactions may identify patterns from user behaviors, such as time spent on specific types of content, navigation paths taken within an application, responses to user interface prompts, and/or the like. In some implementations, the user interface system 110 may utilize the usage pattern to predict future user requests or to dynamically adjust a layout and/or elements of the user interface for improved user experience. For example, the user interface system 110 may utilize predictions generated based on the usage pattern to preload content for the user interface, to prerender elements likely to be accessed by the user interface, and/or the like.

The usage pattern may enable the user interface system 110 to understand user-specific user interface needs, and to generate or adjust the user interface in a way that is tailored to the user's preferences. This may increase an overall utility and efficiency of the user interface, may enhance the user experience by providing more relevant content and layouts, and may provide quicker access for the user to important functions or information.

As shown in FIG. 1B, and by reference number 120, the user interface system 110 may receive a request for a user interface from the client device 105. For example, the user may utilize the client device 105 to access an application (e.g., a mobile application) provided by the user interface system 110. The client device 105 may generate a request for the mobile application and may provide the request to the user interface system 110. In some implementations, the request may include a request for a user interface associated with the mobile application. The user interface system 110 may receive the request for the user interface from the client device 105, and process the request as described below.

As further shown in FIG. 1B, and by reference number 125, the user interface system 110 may generate one or more elements of the user interface based on the request. For example, the mobile application requested by the request may include one or more user interfaces to be rendered on the client device 105. Based on the request, the user interface system 110 may generate the one or more elements for a user interface of the mobile application. The user interface system 110 may generate the one or more elements is based on specifications detailed in the request and/or the mobile application, and also based on the usage pattern of the user. The one or more elements of the user interface may include node structures (e.g., a column layout, a row layout, a box layout, and/or the like) that arrange the one or more elements on the client device 105 to render the user interface based on capabilities of the client device 105 and the usage pattern. The user interface system 110 may dynamically generate the one or more elements for the user interface and may be part of a JavaScript Object Notation (JSON) representation that guides the rendering of the user interface on the client device 105. The one or more elements may include text, images, visual components, interactive elements, or other interface features that facilitate an intuitive and efficient user experience.

As shown in FIG. 1C, and by reference number 130, the user interface system 110 may prompt a large language model (LLM), with the usage pattern, to generate one or more additional elements of the user interface. For example, the user interface system 110 may be associated with an LLM, and may utilize insights derived from the usage pattern to guide the LLM in creating user interface elements (e.g., the one or more additional elements of the user interface) that are tailored to the user's behavior and preferences. The usage pattern may enable the user interface system 110 to enhance the personalization of the user interface. The user interface system 110 may prompt the LLM with the usage pattern by providing the LLM with relevant usage pattern data that the LLM may utilize to generate additional user interface elements that are coherent with a pattern of interaction by the user (e.g., frequent use of certain application features, navigation preferences, or aesthetic inclinations manifested during the user's usage of the client device 105). The one or more additional elements may include text, images, visual components, interactive elements, or other interface features that facilitate an intuitive and efficient user experience.

Alternatively, or additionally, the user interface system 110 may further refine the process by specifying particular styles, formats, or constraints within which the LLM should operate. This may ensure that the one or more additional elements are not only consistent with the usage pattern, but are also aligned with the overall design and operational paradigms of the client device 105. In some implementations, the one or more additional elements of the user interface may include dynamic menus, customized widgets, or interactive guides that augment the one or more elements previously generated based on the initial request from the client device 105. The one or more additional elements may reduce a cognitive load on the user by presenting the user with a more relevant and adaptive user interface, may enhance engagement of the user with the application, and may improve overall satisfaction of the user by creating a responsive and personalized user interface.

As shown in FIG. 1D, and by reference number 135, the user interface system 110 may combine the one or more elements and the one or more additional elements to generate the user interface that includes a node structure corresponding to at least one of a column layout, a row layout, or a box layout for arranging elements on the client device 105. For example, the user interface system 110 may generate the user interface based on combining the one or more elements and the one or more additional elements. In some implementations, the user interface may include a node structure that corresponds to a column layout, a row layout, or a box layout and provides an orderly arrangement of the elements of the user interface on the client device 105. The node structure may include a set of user interface components in a particular style that can be rendered efficiently on any client device 105 and may be arranged using recursion. The arrangement may be based on a column that arranges user interface elements vertically, a row that arranges user interface elements horizontally, and/or a box that places user interface elements on top of one another. Further details of the node structure are described below in connection with FIG. 1H.

In some implementations, an example of the user interface may include the following JSON syntax:
{
   Type: “Row”,
   alignments: {
      // attributes like height, width
   },
   Children: [
      ≡
         “type”: “text”,
         “text”: “Smartphones”,
         “fontWeight”: “bold”,
         “fontSize”: 28,
         “textColor”: “#000000”,
         “alignments”: {
         “paddingStart”: 16,
         “paddingTop”: 26
         }
         // and many more root element attributes such as spacing, font and format attributes
      },
      // and many more children elements
   ],
   Type: “Column”,
   alignments: {
      ///attributes like height, width
   },
   Children: [
      {
         // and many more root element attributes such as spacing, font and format attributes
      },
      // and many more children elements
   ϕ,
   Type: “Box”,
   alignments: {
      //attributes like height, width
   },
   Children: [
      }
         // and many more root element attributes such as spacing, font and format attributes
      },
      {
      }, // and many more children elements
   ]
}.

As shown in FIG. 1E, and by reference number 140, the user interface system 110 may designate one or more portions of the user interface for asynchronous loading and for initiating another request by the client device 105. For example, by designating the one or more portions of the user interface for asynchronous loading, the user interface system 110 may enable the user interface to promptly provide immediate content to the user of the client device 105, while secondary content or less critical elements can be loaded in the background without interrupting or delaying the user's interaction with the immediate content. The user interface system 110 may designate one or more portions of the user interface for asynchronous loading based on providing network addresses (e.g., uniform resource locators (URLs)) or prompts to an LLM in the one or more portions of the user interface. In some implementations, the prompts to the LLM may enable the user interface system 110 to efficiently handle content generation or error resolution without the need for manual error handling and immediate reloading of the user interface.

The asynchronous loading of the user interface may ensure that particular portions of the user interface are displayed by the client device 105 to the user without unnecessary wait times and that non-critical portions of the user interface are loaded as needed. For example, the user interface system 110 may tag a content block for asynchronous loading with a specific URL or a prompt for an LLM. If the client device 105 experiences a delay or an error in loading the content from the provided URL, the client device 105 may automatically switch to the prompt for the LLM to generate a suitable user interface element, thereby enhancing the user experience by mitigating potential disruption caused by loading delays or errors.

Thus, the asynchronous loading of the user interface may provide an improved user experience by reducing perceived loading times and by providing responsive interaction with primary content from the moment the user interface is accessed on the client device 105. Additionally, the asynchronous loading of the user interface may enable the LLM to generate or correct user interface elements, thereby offering a dynamic and adaptive user interface experience. The asynchronous loading of the user interface may be particularly advantageous when network conditions fluctuate or when dealing with large datasets that would otherwise slow down the user experience.

As shown in FIG. 1F, and by reference number 145, the user interface system 110 may generate, based on the user interface, a backup user interface to be utilized by the client device 105 when the user interface experiences an error. For example, the user interface system 110 may generate a backup user interface (e.g., for the user interface) as a preventive measure to enhance the interaction experience at the client device 105. The backup user interface may ensure that the user of the client device 105 can continue to access functionality without significant interruptions.

In some implementations, the user interface system 110 may monitor the user interface provided to the client device 105, and may detect potential errors with the user interface based on the monitoring. In such implementations, the user interface system 110 may preemptively provide the backup user interface to the client device 105 to act as a failover solution. The backup user interface may be based on a simpler, more reliable version of the user interface, or it may be a previous stable version of the user interface that has performed without errors in the past. In some implementations, the user interface system 110 may generate the backup user interface based on the user interface, may utilize a LLM to generate the backup user interface based on the usage pattern of the user, and/or the like. The backup user interface may be utilized when the client device 105 encounters unexpected errors due to software bugs, network issues, or other anomalous conditions resulting in the user interface failing to load or operate correctly. In this way, the user interface system 110 may minimize the impact of such events on the user, may safeguard the user experience, and may enable uninterrupted usage while the errors are addressed and resolved.

As shown in FIG. 1G, and by reference number 150, the user interface system 110 may provide the user interface to the client device 105. For example, the user interface system 110 may transmit the user interface to the client device 105, and the client device 105 may receive and subsequently display the user interface to the user. In some implementations, the user interface may include visual elements, such as text, images, and controls for user input.

As further shown in FIG. 1G, and by reference number 155, the user interface system 110 may detect an error associated with the user interface. For example, when the client device 105 displays the user interface to the user, the user interface may generate and the user interface system 110 may detect the error. The error may relate to data corruption, missing resources, or any condition that deviates from an expected or normal operation of the user interface. In some implementations, the user interface system 110 may detect the error based on integrity checks, user feedback, automated error reporting functions, and/or the like. When the error effects correct functioning of the user interface, the user interface system 110 may take responsive measures to address the detected error.

As further shown in FIG. 1G, and by reference number 160, the user interface system 110 may utilize an LLM to generate a correction for the error associated with the user interface. For example, upon detection of the error, the user interface system 110 may prompt the LLM, with context pertaining to the error and the user interface, to generate a correction for the error. In some implementations, the correction for the error may include code snippets, proposing alternative resources for the user interface, a set of actions or content to mitigate the error, and/or the like.

As further shown in FIG. 1G, and by reference number 165, the user interface system 110 may implement the correction for the error for the client device 105. For example, the user interface system 110 may provide the correction generated by the LLM to the client device 105, and may instruct the client device 105 to implement the correction. This may include the client device 105 patching the user interface with updated code, substituting faulty elements with operational ones, reconfiguring the user interface setup to bypass the error condition, and/or the like. The client device 105 may then display the amended user interface to the user to provide an uninterrupted user experience.

As further shown in FIG. 1G, and by reference number 170, the client device 105 may utilize recursion to render the user interface on the client device 105 and may store one or more portions of the user interface viewed by the user in a cache. For example, the client device 105 may utilize a recursion to traverse the node structure of the user interface as dictated by the received data representation (e.g., a JSON representation), allowing for nested components to be processed and displayed correctly by the client device 105. Further details of the recursion are described below in connection with FIG. 1H. For optimization purposes, the client device 105 may store portions of the user interface interacted with or viewed by the user in the cache memory of the client device 105. By caching the portions of the user interface, the client device 105 may expedite subsequent accesses of the same user interface elements, which may enhance performance by reducing load times and a need for repetitive network requests.

FIG. 1H depicts an example of the client device 105 utilizing recursion to interpret and render the user interface received from the user interface system 110. For example, the client device 105 may utilize recursion to interpret the node structure of the user interface received from the user interface system 110 and to render the user interface for display to the user. As shown, the client device 105 (e.g., the UI processing framework) may process the node structure of the user interface and may identify a row element as a root node with specified alignments that determine a full-screen width and height of the user interface. Using recursion, the client device 105 may unwind the row element to reveal two elements (e.g., an image element and a text element) at the same level below the row element. Each of the image element and the text element may include a set of attributes. Specifically, the image element may include attributes, such as an image URL, alignments, a content scale, and/or the like. The text element may include attributes, such as content, font, format, alignments that specify positioning within the user interface, and/or the like. As the recursion process continues, the attributes of the image element and the text element may indicate that the image element and the text element are terminal nodes within the tree structure (e.g., with no children). Consequently, the client device 105 may recognize that the image element and the text element are ready to be rendered for display. As shown, the client device 105 may draw the image element on the display of the client device 105 with the image URL, alignments, and scale provided by the image attributes, and may draw the text element on the display with the text content, the font, the format, and the alignments provide by the text attributes. This approach effectively enables the client device 105 to dynamically draw user interface components on the display without the need for additional child elements.

The recursive process used by the client device 105 may simplify user interface rendering by utilizing the node structure of the user interface. This provides efficient user interface generation with reduced computational complexity, enhancing the overall user experience by providing a rapid and responsive user interface. Additionally, the recursive process enables a scalable approach to user interface rendering that can adapt to various screen sizes and device capabilities.

In this way, the user interface system 110 provides a user interface with recursive elements and dynamic error handling. For example, the user interface system 110 may ADD. Thus, the user interface system 110 may conserve computing resources, networking resources, and/or other resources that would have otherwise been consumed by failing to properly answer questions appropriately and efficiently with an agent and an LLM, handling user complaints due to failing to properly answer questions appropriately and efficiently, failing to provide correct recommendations based on poorly designed agent and LLM systems, providing irrelevant and inaccurate responses based on poorly designed agent and LLM systems, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

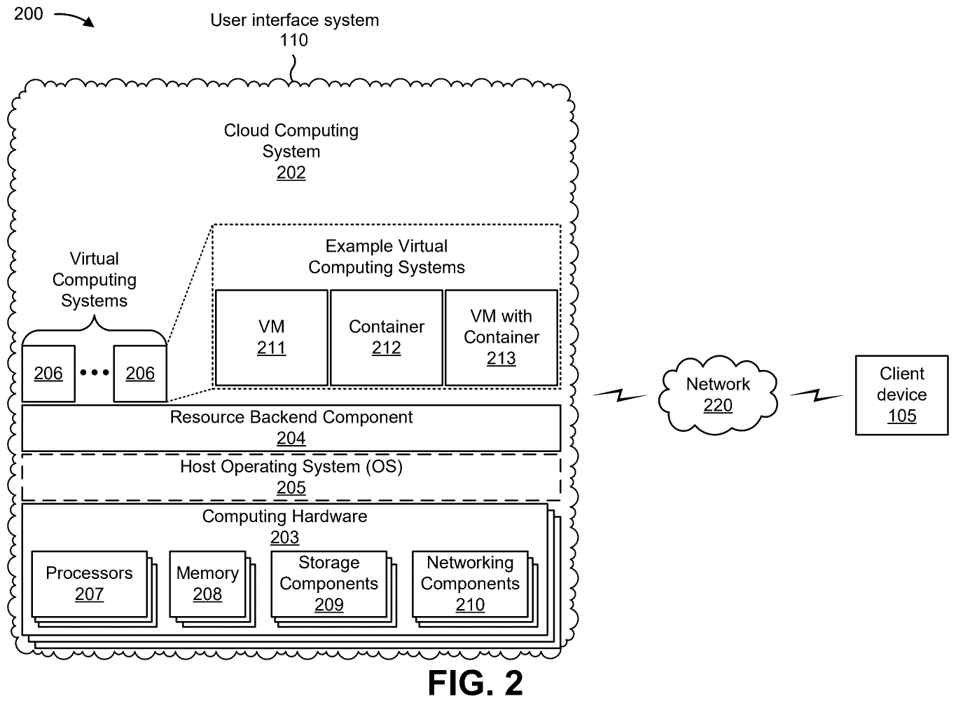

FIG. 2 is a diagram of an example environment 200 in which systems and/or methods described herein may be implemented. As shown in FIG. 2, the environment 200 may include the user interface system 110, which may include one or more elements of and/or may execute within a cloud computing system 202. The cloud computing system 202 may include one or more elements 203-213, as described in more detail below. As further shown in FIG. 2, the environment 200 may include the client device 105 and/or a network 220. Devices and/or elements of the environment 200 may interconnect via wired connections and/or wireless connections.

The client device 105 may include one or more devices capable of receiving, generating, storing, processing, and/or providing information, as described elsewhere herein. The client device 105 may include a communication device and/or a computing device. For example, the client device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 202 includes computing hardware 203, a resource management component 204, a host OS 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

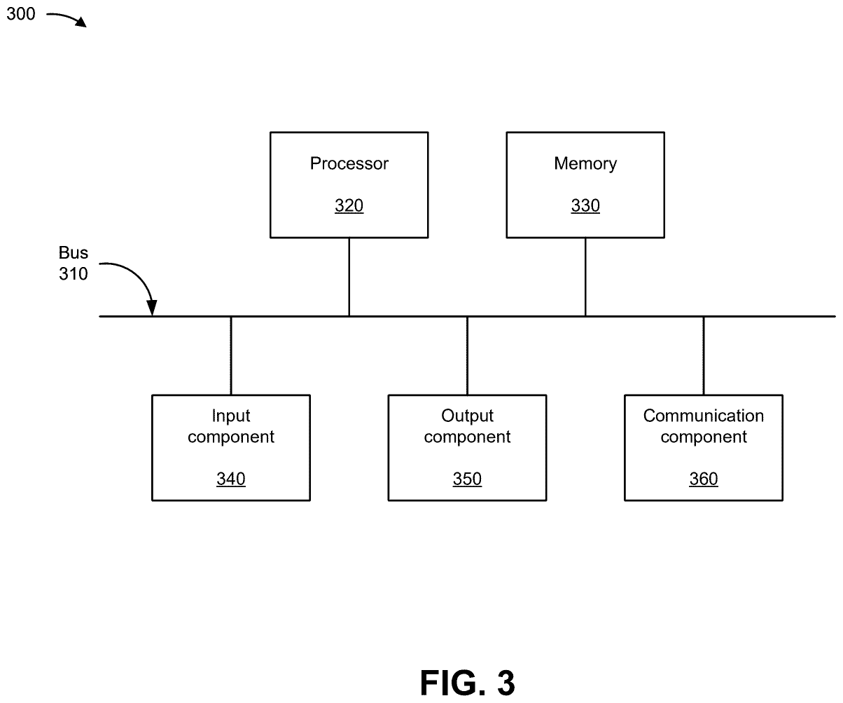

Although the user interface system 110 may include one or more elements 203-213 of the cloud computing system 202, may execute within the cloud computing system 202, and/or may be hosted within the cloud computing system 202, in some implementations, the user interface system 110 may not be cloud-based (e.g., may be implemented outside of a cloud computing system) or may be partially cloud-based. For example, the user interface system 110 may include one or more devices that are not part of the cloud computing system 202, such as the device 300 of FIG. 3, which may include a standalone server or another type of computing device. The user interface system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the client device 105 and/or the user interface system 110. In some implementations, the client device 105 and/or the user interface system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

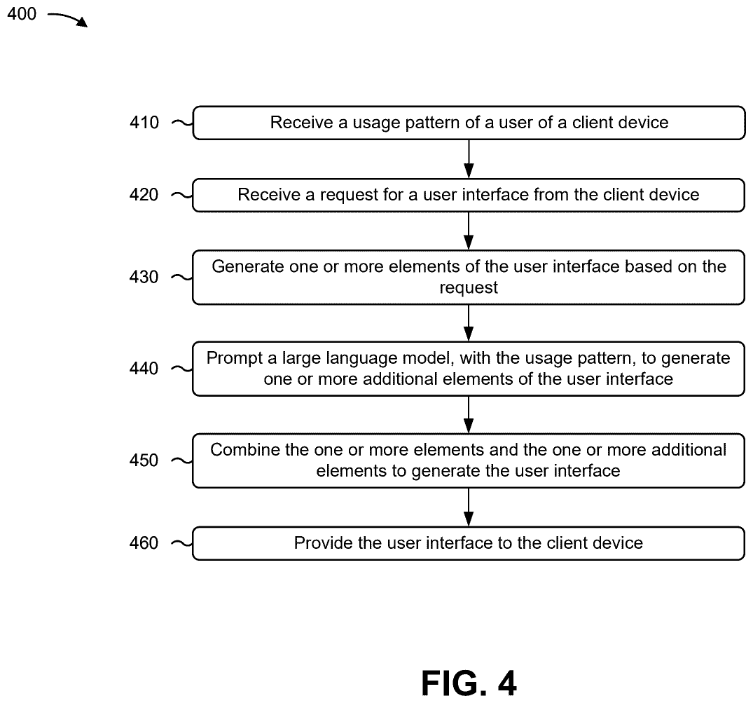

FIG. 4 is a flowchart of an example process 400 for providing a user interface with recursive elements and dynamic error handling. In some implementations, one or more process blocks of FIG. 4 may be performed by a device (e.g., the user interface system 110). In some implementations, one or more process blocks of FIG. 4 may be performed by another device or a group of devices separate from or including the device, such as a client device (e.g., the client device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a usage pattern of a user of a client device (block 410). For example, the device may receive a usage pattern of a user of a client device, as described above.

As further shown in FIG. 4, process 400 may include receiving a request for a user interface from the client device (block 420). For example, the device may receive a request for a user interface from the client device, as described above.

As further shown in FIG. 4, process 400 may include generating one or more elements of the user interface based on the request (block 430). For example, the device may generate one or more elements of the user interface based on the request, as described above.

As further shown in FIG. 4, process 400 may include prompting a large language model, with the usage pattern, to generate one or more additional elements of the user interface (block 440). For example, the device may prompt a large language model, with the usage pattern, to generate one or more additional elements of the user interface, as described above.

As further shown in FIG. 4, process 400 may include combining the one or more elements and the one or more additional elements to generate the user interface (block 450). For example, the device may combine the one or more elements and the one or more additional elements to generate the user interface, as described above. In some implementations, the user interface includes a node structure corresponding to at least one of column layout, a row layout, or a box layout for arranging elements on the client device. In some implementations, combining the one or more elements and the one or more additional elements to generate the user interface includes utilizing a recursive model to generate the user interface based on the one or more elements and the one or more additional elements. In some implementations, combining the one or more elements and the one or more additional elements to generate the user interface includes determining a screen size and one or more capabilities associated with the client device, and dynamically resizing or rearrange the one or more elements and the one or more additional elements to generate the user interface based on the screen size and the one or more capabilities associated with the client device.

As further shown in FIG. 4, process 400 may include providing the user interface to the client device (block 460). For example, the device may provide the user interface to the client device, as described above. In some implementations, the user interface is renderable via recursion on the client device. In some implementations, one or more portions of the user interface viewed by the user are storable in a cache of the client device. In some implementations, the user interface includes a JSON representation of the one or more elements and the one or more additional elements. In some implementations, providing the user interface to the client device includes determining network conditions associated with providing the user interface to the client device, and adjusting transmission parameters associated with providing the user interface to the client device based on the network conditions.

In some implementations, process 400 includes designating, prior to providing the user interface to the client device, one or more portions of the user interface for asynchronous loading and for initiating another request by the client device. In some implementations, process 400 includes generating, based on the user interface and prior to providing the user interface to the client device, a backup user interface to be utilized by the client device when the user interface experiences an error.

In some implementations, process 400 includes detecting an error associated with the user interface, utilizing another large language model to generate a correction for the error associated with the user interface, and implementing the correction for the error for the client device. In some implementations, process 400 includes predicting a future request of the client device based on the usage pattern, and generating a future user interface based of the future request. In some implementations, process 400 includes embedding, in the user interface and prior to providing the user interface to the client device, one or more network identifiers for asynchronous loading of secondary elements by the client device.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a usage pattern of a user of a client device;
receiving, by the device, a request for a user interface from the client device;
generating, by the device, one or more elements of the user interface based on the request;
prompting, by the device, a large language model, with the usage pattern, to generate one or more additional elements of the user interface;
combining, by the device, the one or more elements and the one or more additional elements to generate the user interface; and
providing, by the device, the user interface to the client device.

2. The method of claim 1, wherein the user interface includes a node structure corresponding to at least one of column layout, a row layout, or a box layout for arranging elements on the client device.

3. The method of claim 1, further comprising:
designating, prior to providing the user interface to the client device, one or more portions of the user interface for asynchronous loading and for initiating another request by the client device.

4. The method of claim 1, further comprising:
generating, based on the user interface and prior to providing the user interface to the client device, a backup user interface to be utilized by the client device when the user interface experiences an error.

5. The method of claim 1, further comprising:
detecting an error associated with the user interface;
utilizing another large language model to generate a correction for the error associated with the user interface; and
implementing the correction for the error for the client device.

6. The method of claim 1, wherein the user interface is renderable via recursion on the client device.

7. The method of claim 1, wherein one or more portions of the user interface viewed by the user are storable in a cache of the client device.

8. A device, comprising:
one or more processors configured to:
receive a usage pattern of a user of a client device;
receive a request for a user interface from the client device;
generate one or more elements of the user interface based on the request;
prompt a large language model, with the usage pattern, to generate one or more additional elements of the user interface;
combine the one or more elements and the one or more additional elements to generate the user interface,
wherein the user interface includes a node structure corresponding to at least one of column layout, a row layout, or a box layout for arranging elements on the client device; and
provide the user interface to the client device.

9. The device of claim 8, wherein the one or more processors are further configured to:
predict a future request of the client device based on the usage pattern; and
generate a future user interface based of the future request.

10. The device of claim 8, wherein the user interface includes a JavaScript Object Notation representation of the one or more elements and the one or more additional elements.

11. The device of claim 8, wherein the one or more processors are further configured to:
embed, in the user interface and prior to providing the user interface to the client device, one or more network identifiers for asynchronous loading of secondary elements by the client device.

12. The device of claim 8, wherein the one or more processors, to combine the one or more elements and the one or more additional elements to generate the user interface, are configured to:
utilize a recursive model to generate the user interface based on the one or more elements and the one or more additional elements.

13. The device of claim 8, wherein the one or more processors, to combine the one or more elements and the one or more additional elements to generate the user interface, are configured to:
determine a screen size and one or more capabilities associated with the client device; and
dynamically resize or rearrange the one or more elements and the one or more additional elements to generate the user interface based on the screen size and the one or more capabilities associated with the client device.

14. The device of claim 8, wherein the one or more processors, to provide the user interface to the client device, are configured to:
determine network conditions associated with providing the user interface to the client device; and
adjust transmission parameters associated with providing the user interface to the client device based on the network conditions.

15. A non-transitory computer-readable medium storing a set of instructions, the set of instructions comprising:
one or more instructions that, when executed by one or more processors of a device, cause the device to:
receive a usage pattern of a user of a client device;
receive a request for a user interface from the client device;
generate one or more elements of the user interface based on the request;
prompt a large language model, with the usage pattern, to generate one or more additional elements of the user interface;
combine the one or more elements and the one or more additional elements to generate the user interface;
designate one or more portions of the user interface for asynchronous loading and for initiating another request by the client device; and
provide the user interface to the client device.

16. The non-transitory computer-readable medium of claim 15, wherein the one or more instructions further cause the device to:
generate, based on the user interface and prior to providing the user interface to the client device, a backup user interface to be utilized by the client device when the user interface experiences an error.

17. The non-transitory computer-readable medium of claim 15, wherein the one or more instructions further cause the device to:
detect an error associated with the user interface;
utilize another large language model to generate a correction for the error associated with the user interface; and
implement the correction for the error for the client device.

18. The non-transitory computer-readable medium of claim 15, wherein the one or more instructions further cause the device to:
predict a future request of the client device based on the usage pattern; and
generate a future user interface based of the future request.

19. The non-transitory computer-readable medium of claim 15, wherein the one or more instructions, that cause the device to combine the one or more elements and the one or more additional elements to generate the user interface, cause the device to:
utilize a recursive model to generate the user interface based on the one or more elements and the one or more additional elements.

20. The non-transitory computer-readable medium of claim 15, wherein the one or more instructions, that cause the device to combine the one or more elements and the one or more additional elements to generate the user interface, cause the device to:
determine a screen size and one or more capabilities associated with the client device; and
dynamically resize or rearrange the one or more elements and the one or more additional elements to generate the user interface based on the screen size and the one or more capabilities associated with the client device.
